(19) United States
(12) Patent Application Publication
(10) Pub. No.: US 2026/0299294 A1
(43) Pub. Date: Oct. 1, 2026

(54) METHODS FOR FABRICATING LIGHT-GUIDE OPTICAL ELEMENTS

(71) Applicant: LUMUS LTD., Ness Ziona (IL)

(72) Inventors: Elad SHARLIN, Mishmar David (IL); Ido FUCHS, Ness Ziona (IL); Tsion EISENFELD, Ashkelon (IL); Yochay DANZIGER, Kfar Vradim (IL); Ronen CHRIKI, Lod (IL); Amir SHAPIRA, Ness Ziona (IL); Eitan RONEN, Rechovot (IL)

(21) Appl. No.: 19/489,335

(22) PCT Filed: Jun. 10, 2024
(86) PCT No.: PCT/IL2024/050577

§ 371 Date: Dec. 2, 2025

Related U.S. Application Data
(60) Provisional application No. 63/521,409, filed on Jun. 16, 2023.

(51) Int. Cl. G02B 27/01; B29D 11/00; G02B 27/00

(52) U.S. Cl. CPC G02B 27/0101; B29D 11/00596; B29D 11/00692; B29D 11/0073; G02B 27/0081; G02B 2027/0163; G02B 2027/0169; G02B 2027/0196

(57) ABSTRACT

An optical device is fabricated by obtaining at least one optical element and a frame. The at least one optical element is arranged within the frame according to a spatial configuration that defines a position of the at least one optical element in the frame and an orientation of the at least one optical element relative to the frame. The at least one optical element is bonded to the frame to fix the spatial configuration, and regions of the frame unoccupied by the at least one optical element are filled with a transparent optical material.

### CROSS-REFERENCE TO RELATED APPLICATIONS

This application claims priority from U.S. Provisional Patent Application No. 63/521,409, filed Jun. 16, 2023, whose disclosure is incorporated by reference in its entirety herein.

### TECHNICAL FIELD

The present disclosure relates to optical systems, and, in particular, it concerns methods for fabricating optical devices including light-guide optical elements.

### BACKGROUND OF THE INVENTION

Optical arrangements for near eye display (NED), head mounted display (HMD) and head up display (HUD) require large aperture to cover the area where the observer's (user's) eye is located (commonly referred to as the eye-motion box—or EMB). In order to implement a compact device, the image that is to be projected into the observer's eye is generated by a small optical image generator (projector) having a small optical aperture. The image from the image projector is conveyed to the eye by an optical combiner, which can be implemented as a light-guide optical element (LOE) having one or more sets of mutually-parallel partially-reflecting internal surfaces, which expands (multiplies) the image in one or two dimensions to generate a large aperture.

### SUMMARY OF THE INVENTION

The present disclosure provides methods for fabricating optical devices including light-guide optical elements (LOEs).

According to the teachings of an embodiment of the present disclosure, there is provided a method for fabricating an optical device. The method comprises: obtaining at least one optical element; obtaining a frame; arranging the at least one optical element within the frame according to a spatial configuration that defines a position of the at least one optical element in the frame and an orientation of the at least one optical element relative to the frame; bonding the at least one optical element to the frame to fix the spatial configuration; and filling regions of the frame unoccupied by the at least one optical element with a transparent optical material.

Optionally, the method further comprises: prior to filling the regions of the frame with the transparent optical material, arranging the frame between a pair of parallel surfaces such that the at least one optical element is located between the parallel surfaces.

Optionally, the method further comprises: curing the transparent optical material.

Optionally, the at least one optical element is constructed from a material that is the same as the transparent optical material.

Optionally, the at least one optical element is constructed from a glass material having a low glass-transition temperature or a plastic or polymer material having a high glass-transition temperature.

Optionally, arranging the at least one optical element within the frame includes deploying a device that places each optical element of the at least one optical element according to the spatial configuration.

Optionally, the at least one optical element has an embedded material internal to the at least one optical element that is sensitive to at least one of an electric field or a magnetic field.

Optionally, arranging the at least one optical element within the frame is performed at least in part by applying at least one of an electric field or a magnetic field to the embedded material internal to the at least one optical element.

Optionally, the embedded material includes at least one of a ferromagnetic material or a dielectric material.

Optionally, the at least one optical element includes a planar partially-reflecting surface.

Optionally, the at least one optical element includes a lens.

Optionally, the at least one optical element includes a polarizing beam splitter.

Optionally, the at least one optical element includes an optical retarder.

Optionally, the at least one optical element includes a reflective surface.

Optionally, the at least one optical element includes a plurality of optical elements.

Optionally, the plurality of optical elements includes a first plurality of planar partially-reflecting surfaces.

Optionally, the orientation defined by the spatial configuration is such that the first plurality of partially-reflecting surfaces are obliquely inclined relative to a pair of parallel surfaces between which the frame is located.

Optionally, the orientation defined by the spatial configuration is such that the first plurality of partially-reflecting surfaces are perpendicular to a pair of parallel surfaces between which the frame is located.

Optionally, the orientation defined by the spatial configuration is such that the first plurality of partially-reflecting surfaces are mutually parallel.

Optionally, the method further comprises: obtaining a second plurality of planar partially-reflecting surfaces; and arranging the second plurality of partially-reflecting surfaces within the frame according to a second spatial configuration that defines a position of the second plurality of partially-reflecting surfaces in the frame and an orientation of the second plurality of partially-reflecting surfaces relative to the frame, and the orientation defined by the second spatial configuration is such that the second plurality of partially-reflecting surfaces are mutually parallel and non-parallel to the first plurality of partially-reflecting surfaces.

Optionally, the at least one optical element includes a plurality of planar partially-reflecting surfaces, and obtaining the at least one optical element includes: obtaining a production plate formed from glass having low glass-transition temperature or a plastic or polymer material having a high glass-transition temperature, coating the production plate with a partially-reflecting coating, and slicing the coated production plate to produce a plurality of coated plates, each coated plate being a planar partially-reflecting surface.

Optionally, the at least one optical element includes a plurality of planar partially-reflecting surfaces, and obtaining the at least one optical element includes: obtaining a plurality of production plates, each production plate formed from glass having a low glass-transition temperature or a plastic or polymer material having a high glass-transition temperature, coating each of the production plates with a partially-reflecting coating, stacking the coated production plates in a stack and temporarily bonding together the coated production plates with a temporary adhesive, and slicing the stack and removing the temporary adhesive to produce a plurality of coated plates, each coated plate being a planar partially-reflecting surface.

Optionally, obtaining the at least one optical element includes: obtaining an amount of a material that is sensitive to at least one of an electric field or a magnetic field, and embedding the amount of the material in an optical material to form the at least one optical element.

There is also provided according to the teachings of an embodiment of the present disclosure a method for fabricating an optical device. The method comprises: obtaining at least one optical element; obtaining a block of transparent material, the block of transparent material having at least one opening, the at least one opening and the at least one optical element being correspondingly configured, each opening of the at least one opening defining an internal surface of the block having a spatial configuration that defines a position of the internal surface in the block and an orientation of the internal surface relative to an external face of the block; inserting each optical element of the at least one optical element into a corresponding opening of the at least one opening; and bonding each optical element of the at least one optical element in the corresponding opening.

Optionally, the method further comprises: arranging the block between a pair of parallel surfaces such that the at least one optical element is located between the plates; and filling areas between the parallel surfaces and the block with a transparent filling material.

Optionally, the transparent filling material includes at least one of an optical adhesive or an index-matching liquid.

Optionally, the transparent material is glass having a low glass-transition temperature or a plastic or polymer material having a high glass-transition temperature.

Optionally, the at least one optical element is constructed from glass having a low glass-transition temperature or a plastic or polymer material having a high glass-transition temperature.

Optionally, the at least one optical element includes a planar partially-reflecting surface.

Optionally, the at least one optical element includes a lens.

Optionally, the at least one optical element includes a polarizing beam splitter.

Optionally, the at least one optical element includes an optical retarder.

Optionally, the at least one optical element includes a plurality of planar partially-reflecting surfaces.

Optionally, the at least one opening includes a plurality of openings that define a plurality of first internal surfaces, and the orientation of the first internal surfaces defined by the spatial configuration such that the first internal surfaces are mutually parallel.

Optionally, the at least one optical element includes a first plurality of planar partially-reflecting surfaces, the block of transparent material has a second plurality of openings, each of the openings of the second plurality of openings defining a second internal surface of the block having a second spatial configuration that defines a position of the second internal surface in the block and an orientation of the second internal surface relative to an external face of the block, and the orientation of the second internal surfaces defined by the second spatial configuration such that the second internal surfaces are mutually parallel and non-parallel to the first internal surfaces, and the method further comprises: obtaining a second plurality of planar partially-reflecting, the second plurality of the openings and the second plurality of partially-reflecting surfaces being correspondingly configured; inserting each partially-reflecting surface of the second plurality of partially-reflecting surfaces into a corresponding one of the openings of the second plurality of elongated openings; and bonding the partially-reflecting surfaces of the second plurality of partially-reflecting surfaces in the openings of the second plurality of openings.

Optionally, obtaining the block of transparent material includes: obtaining a solid block of transparent material, and removing at least one portion of the solid block to produce the at least one opening.

Throughout this document, references are made to optical materials as being low index material, medium index materials, and high index material. Within the context of this document, an optical material is considered to be a high index material if the refractive index of the optical material is greater than or equal to approximately 1.7. Also, within the context of this document, an optical material is considered to be a low index material if the refractive index of the optical material is in a range between approximately 1 and approximately 1.53. Also, within the context of this document, an optical material is considered to be a medium index material if it is neither a low index material nor a high index material, in other words the refractive index of the optical material is in a range between approximately 1.53 and 1.7.

Unless otherwise defined herein, all technical and/or scientific terms used herein have the same meaning as commonly understood by one of ordinary skill in the art to which the disclosure pertains. Although methods and materials similar or equivalent to those described herein may be used in the practice or testing of embodiments of the disclosure, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the present disclosure are herein described, by way of example only, with reference to the accompanying drawings. With specific reference to the drawings in detail, it is stressed that the particulars shown are by way of example and for purposes of illustrative discussion of embodiments of the disclosure. In this regard, the description taken with the drawings makes apparent to those skilled in the art how embodiments of the disclosure may be practiced.

Attention is now directed to the drawings, where like reference numerals or characters indicate corresponding or like components. In the drawings:

FIG. 1 is a schematic side view illustrating an optical device in the form of a light-guide optical (LOE), having a set of major external surfaces and a set of mutually parallel partially-reflecting internal surfaces obliquely inclined relative to the major external surfaces for achieving one-dimensional aperture expansion, that can be fabricated using methods according to embodiments of the present disclosure;

FIG. 2 is a schematic representation of an optical device in the form of an LOE, having first and second sets of mutually parallel partially-reflecting internal surfaces in which the orientation of the first set of surfaces is non-parallel to the orientation of the second set of surfaces for achieving two-dimensional aperture expansion, that can be fabricated using methods according to embodiments of the present disclosure;

FIGS. 3A-3N illustrate steps for fabricating an optical device implemented as an LOE, according to embodiments of the present disclosure;

FIG. 4 illustrates a robotic device that can be used for arranging partially-reflecting surfaces as part of fabrication steps of an optical device, according to embodiments of the present disclosure;

FIG. 5 is a schematic representation of a device implemented as an optical-test bench equipment that can be used for arranging partially-reflecting surfaces as part of fabrication steps of an LOE, according to embodiments of the present disclosure;

FIG. 6 schematically illustrates an arrangement that can be used in mass-production of optical devices, according to embodiments of the present disclosure;

FIGS. 7A-7C illustrate steps for manufacturing partially-reflecting surfaces, according to embodiments of the present disclosure;

FIGS. 8A-8F illustrate steps for manufacturing partially-reflecting surfaces, according to another set of embodiments of the present disclosure;

FIGS. 9A-9F illustrate steps for mass-producing partially-reflecting surfaces, according to yet another set of embodiments of the present disclosure;

FIG. 10 is a schematic representation of a device that can be used, as part of fabrication steps of an LOE, to arrange partially-reflecting surfaces having magnetic material and/or dielectric material embedded therein by applying electric fields and/or magnetic fields to the partially-reflecting surfaces, according to embodiments of the present disclosure;

FIGS. 11A-11D illustrate steps for fabricating an optical device implemented as an LOE, according to another set of embodiments of the present disclosure;

FIGS. 12A-12C illustrate steps for fabricating an LOE, according to yet another set of embodiments of the present disclosure

FIGS. 13A and 13B illustrate steps for fabricating an LOE, according to a further set of embodiments of the present disclosure; and

FIG. 14 is a graph showing reflectance curves for p-polarized light and s-polarized light at a particular angular range of between 40° and 60°.

### DESCRIPTION OF THE PREFERRED EMBODIMENTS

Certain embodiments of the present disclosure provide methods for fabricating LOEs.

The principles and operation of the methods according to the present disclosure may be better understood with reference to the drawings accompanying the description.

Before explaining at least one embodiment of the disclosure in detail, it is to be understood that the disclosure is not necessarily limited in its application to the details of construction and the arrangement of the components and/or methods set forth in the following description and/or illustrated in the drawings and/or the examples. The disclosure is capable of other embodiments or of being practiced or carried out in various ways.

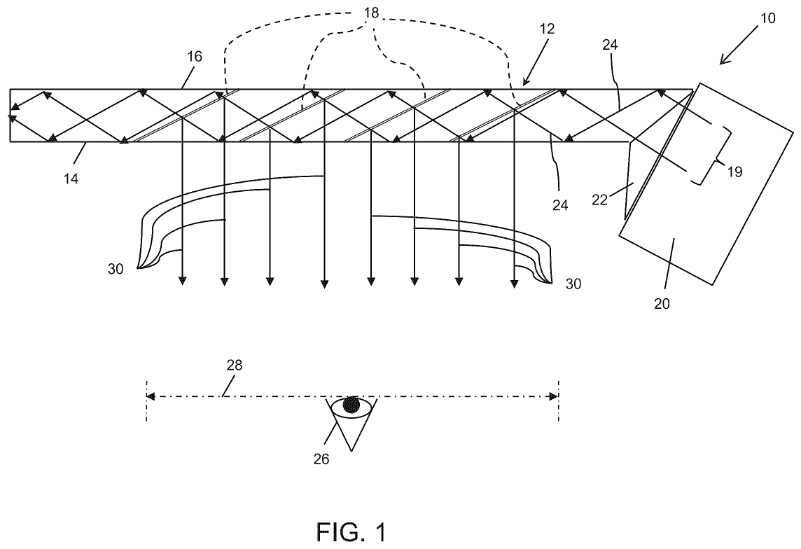

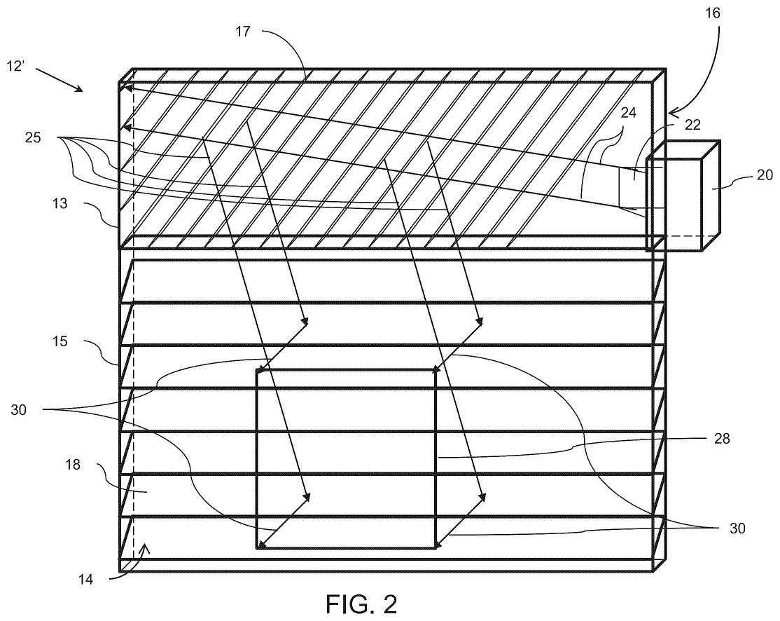

By way of introduction, FIGS. 1 and 2 illustrate certain particularly preferred examples of optical devices for which the fabrication methods of the present disclosure are particularly relevant, although the fabrication methods are not limited to such applications.

An exemplary implementation of an optical device, generally designated 10, employing an LOE (also referred to as “substrate”) 12 according to the present disclosure, is illustrated schematically in FIG. 1. The LOE 12 is formed from transparent (i.e., light-transmitting) material, and includes a set (pair) of mutually-parallel major external surfaces 14, 16 and a set of planar, mutually-parallel, partially-reflecting surfaces (“facets”) 18. The facets 18 are internal to the LOE 12, i.e., they are located between the major external surfaces 14, 16, and are obliquely inclined relative to the major external surfaces 14, 16. A compact image projector 20 is optically coupled with the LOE 12 via a suitable optical coupling configuration 22 (represented in the drawings as a coupling prism, but may be of other suitable forms such as a coupling reflector) so as to inject image illumination (corresponding to a collimated image) 19 into the LOE 12 within which the image light is trapped by internal reflection at the major external surfaces 14, 16. The propagating image light (represented as rays 24) interacts with the facets 18, which progressively deflect (couples-out) a proportion of the image illumination (represented as rays 30) out of the LOE 12 towards the eye 26 of an observer located within a region defined as the eye-motion box (EMB) 28, thereby achieving expansion of the optical aperture in one dimension.

FIG. 2 illustrates another exemplary implementation of an optical device according to the present disclosure, which employs an LOE 12′ that achieves two-dimensional aperture expansion. Here, the LOE 12′ includes two regions, designated 13 and 15, each having its own set of facets 17 and 18 with its own orientation. The major external surfaces 14, 16 extend across the two regions 13 and 15 such that both sets of facets 17 and 18 are located between the major external surfaces 14, 16. Most preferably, the major external surfaces 14, 16 are a pair of surfaces which are each continuous across the entirety of the two regions 13 and 15, although the option of having a set down or a step up in thickness between the regions 13 and 15 also falls within the scope of the present disclosure. The regions 13 and 15 may be immediately juxtaposed so that they meet at a boundary, which may be a straight boundary or some other form of boundary, or there may be one or more additional LOE region interposed between those regions, to provide various additional optical or mechanical function, depending upon the particular application. Although the present disclosure is not limited to any particular manufacturing technique, in certain particularly preferred implementations, particularly high quality major external surfaces are achieved by employing continuous external plates between which the separately formed regions 13 and 15 are sandwiched to form the compound LOE structure.

In FIG. 2, the compact image projector 20 is optically coupled with the LOE 12′ so as to inject image illumination into the LOE region 13 via the coupling prism 22 within which the image light is trapped (propagates) by internal reflection at the major external surfaces 14, 16. The propagating image illumination (rays 24) impinges on the facets 17 in the region 13, with each successive facet deflecting a proportion of the image illumination into a deflected direction, also trapped/guided by internal reflection within the LOE 12′. This partial reflection at successive facets achieves a first dimension of optical aperture expansion. In a first set of preferred but non-limiting examples of the present disclosure, the set of facets 17 in the region 13 are orthogonal to the major external surfaces 14, 16 of the LOE 12′. In this case, both the injected image and its conjugate undergoing internal reflection as it propagates within region 13 are deflected and become conjugate images propagating in a deflected direction. In an alternative set of preferred but non-limiting examples, the facets 17 are obliquely angled relative to the major external surfaces 14, 16. In the latter case, either the injected image or its conjugate forms the desired deflected image propagating within the LOE 12′, while the other reflection may be minimized, for example, by employing angularly-selective coatings on the facets which render them relatively transparent to the range of incident angles presented by the image whose reflection is not needed.

The facets 17 have an orientation that is non-parallel to the orientation of the facets 18 and are specifically oriented so that a part of image illumination 24 propagating within the LOE 12′ by internal reflection at the major external surfaces 14, 16 from the coupling-in region (coupling prism 22) is deflected out of the region 13 and towards (into) the region 15. The deflected image illumination (represented as rays 25) from the region 13 then passes into the other region 15, which may be implemented as an adjacent distinct substrate or as a continuation of a single substrate. The facets 18, whose orientation is such that the facets 18 are obliquely inclined relative to the major external surfaces 14, 16, progressively couple out a proportion of the image illumination 25 propagating within the LOE 12′ by internal reflection at the major external surfaces 14, 16 from the region 13 into the region 15, towards the eye of the observer located in the EMB 28, thereby achieving a second dimension of optical aperture expansion. The coupled-out illumination is represented as rays 30.

Conventional methods for producing LOEs typically rely on steps of coating transparent plates (referred to as “production plates”) with partially-reflecting coating, and then stacking the coated plates and bonding together the stacked plates. To produce LOEs that achieve one-dimensional aperture expansion (“1D LOEs”), such as the LOE illustrated in FIG. 1, the bonded stack is then cut along a series of parallel cutting planes that are angulated relative to external faces of the stack to extract the 1D LOEs. The angulation of the cutting planes defines the oblique inclination angle of the facets in the final LOE product. Examples of 1D LOE production methods are described in detail in various patent publications by Lumus Ltd. (Israel), including, for example, U.S. Pat. No. 8,873,150, PCT publication WO 2016/103263, and PCT publication WO 2020/212835, which are incorporated by reference in their entireties herein.

To produce LOEs that achieve two-dimensional aperture expansion (“2D LOEs”), such as the LOE illustrated in FIG. 2, a similar stack of coated plates is formed, which is then bonded to a bonded stack of 1D LOEs such that the coated plates of the second stack and the facets of the 1D LOEs are non-parallel to each other. The bonded structure is then cut along a series of parallel cutting planes, typically parallel to the major surfaces of the 1D LOEs, to extract the 2D LOEs. Examples of conventional 2D LOE production methods are described in detail in various patent publications by Lumus Ltd. (Israel), including, for example, PCT publication WO 2021/240513, PCT publication WO 2021/152602, PCT publication WO 2021/001841, and U.S. Pat. No. 10,551,544, which are incorporated by reference in their entireties herein.

In the above-described methods, the stacking and bonding steps are performed under tight optical tolerances, to ensure parallelism between the facets and parallelism between the major external surfaces. In addition, inclusion of non-coated elements, such as optical retarders, polarizing beam splitters, fully reflective surfaces (i.e., mirrors), and lenses, in the LOEs introduces fabrication issues when employing the conventional methods, as each of these elements must withstand the typically harsh stacking and bonding fabrication steps, while also adding time-consuming optical testing to ensure that the non-coated elements were not damaged during fabrication and still properly function optically.

Certain embodiments of the present disclosure provide methods for fabricating optical device, including LOEs, that do not rely on stacking and bonding production plates. Rather, as will be described, these embodiments rely on placement of fabricated partially-reflecting surfaces in a frame structure or an optical structure having correspondingly configured openings. Other embodiments of the present disclosure do still rely on stacking and bonding plates, however they do not employ coated plates but rather employ high index optical adhesive deployed between lower index optical plates, to achieve partial reflective functionality. The advantages of the fabrication methods of the present disclosure will become apparent from the following description.

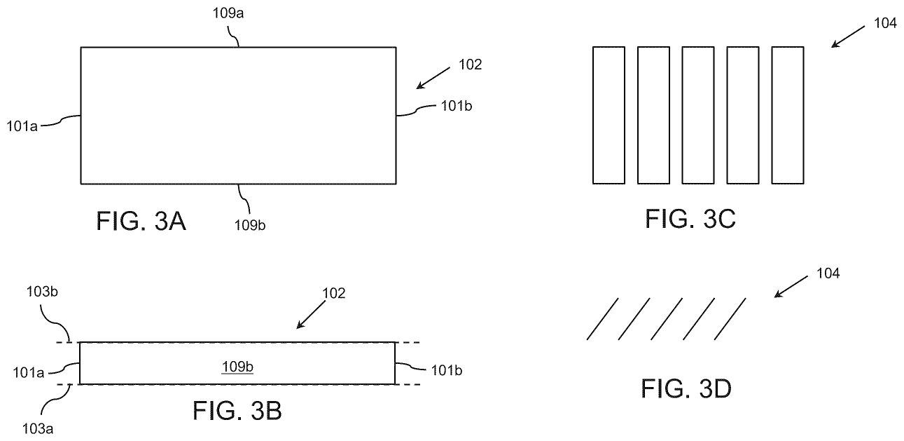

Referring now to FIGS. 3A-3N, there is illustrated a method for fabricating an optical device, which may be an LOE, according to a non-limiting example embodiment of the present disclosure. In the illustrated embodiment, a frame member 102, which is preferably a hollow (i.e., empty) frame is obtained, as shown in the top and side views of FIGS. 3A and 3B. The frame member 102 is a carrier member that is configured to have at least one optical element bonded thereto (as will be discussed below), and can be a rigid member which may be constructed from any suitable material, such as, for example plastic or aluminum or a material having a low thermal expansion coefficient (such as Zerodur®, commercially available from Schott AG of Munich, Germany) to ensure that the bonded optical element(s) remain in place after bonding during the remaining steps of the fabrication process (which can include thermal processing steps). In the non-limiting embodiments illustrated in the drawings, the frame 102 includes first and second pairs of planar (rectangular) parallel sidewalls 101a, 101b, 109a, 109b so that the frame 102 has a rectangular cross-section in a plane that is perpendicular to the sidewalls 101a, 101b, 109a, 109b (i.e., the plane of the paper). The hollow opening top and bottom of the frame 102 are bounded by first and second parallel planes 103a and 103b, respectively. Although the frame 102 is shown in the drawings as having a rectangular cross-section and as being formed from rectangular sidewalls, various sidewall arrangements and geometries can be used to construct the frame, including, for example, polygonal or non-polygonal sidewalls. For example, embodiments are contemplated herein in which the frame is formed from curved sidewalls so that the frame has a non-polygonal cross-section in the plane of the paper.

As illustrated in the top and side views of FIGS. 3C and 3D, at least one optical element 104 is also obtained. In the non-limiting example embodiment, the at least one optical element 104 is implemented as a set (plurality) of planar partially-reflecting surfaces (referred to hereinafter as “facets”). The facets 104 are preferably of equal size and dimension, and can be constructed from a base element, such as an optical plate, having a partially-reflecting coating applied thereto. In certain embodiments, all of the facets are formed from a base element with a partially-reflecting coating applied to one side of the base element (referred to as one-side or single-side coated facets). In other embodiments, each facet of a first subset of the facets is formed from a base element with partially-reflecting coating applied to both sides of the base element (referred to as double-side coated facets), and each facet of a second subset of the facets is formed from an un-coated base element (referred to as un-coated facets).

Examples of methods for constructing the facets will be described in subsequent sections of the present disclosure.

Parenthetically, although the embodiment illustrated in FIGS. 3A-3N will be described in the context of the at least one optical element 104 being a set of facets, the at least one optical element 104 may be implemented as one or more other types of coated optical elements, such as a reflective surface (i.e., mirror) and/or one or more types of non-coated optical elements, including, but not limited to, a lens, a polarizing beam splitter, an optical retarder (e.g., a waveplate).

Turning now to FIGS. 3E and 3F, which show top and side views, respectively, the optical element 104 is arranged within the frame 102 according to a spatial configuration, preferably a prescribed spatial configuration. The spatial configuration of the optical element 104 within the frame 102 defines a position (location) of the optical element 104 in the frame 102 and an orientation of the optical element 104 relative to the frame 102. The orientation includes angular orientation in three-dimensional space, which in the case of facets 104 can include three angles of the plane of each facet relative to a central plane of the frame 102. In embodiments in which the optical device under fabrication is an LOE, the orientation of the facets 104 defined by the spatial configuration is such that the facets 104 are mutually parallel. In certain embodiments, the spatial orientation of the facets 104 is preferably such that first long sides (i.e., ends, edges) 105a of the facets 104 are bounded by a first bounding plane and second long sides (ends or edges) 105b of the facets 104 are bounded by a second bounding plane parallel to the first bounding plane. The first and second bounding planes (which bound the first and second long sides 105a and 105b, respectively) may be parallel to the planes 103a and 103b, or may be non-parallel to the planes 103a and 103b.

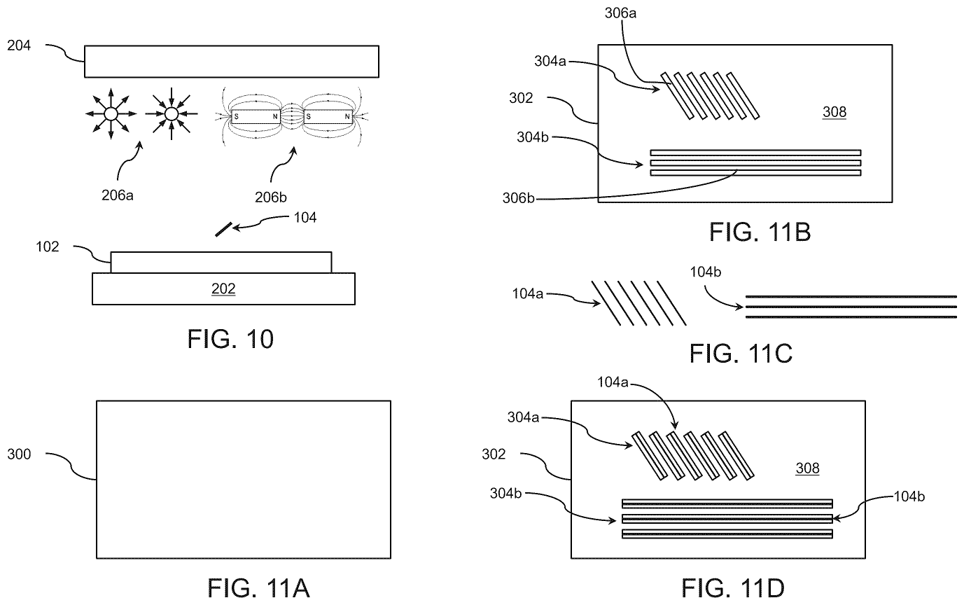

Once the facets 104 are arranged according to the spatial configuration, the facets 104 are bonded to the frame 102 to fix the spatial configuration. Throughout this document, the terms “bonded” or “bonding” should be understood to mean attaching with a glue/adhesive, which can be an optical glue (also referred to as optical cement or optical adhesive), depending on the particular case. For example, the glue that is used to bond the facets 104 to frame 102 does not necessarily need to be an optical glue, whereas the glue that is used in the embodiments described with reference to FIGS. 11A-11D may or may not be an optical glue.

In certain embodiments, the glue/adhesive used for bonding the facets 104 to the frame 102 requires activation or crosslinking by means of ultraviolet (UV) curing (e.g., via a UV lamp), oxygen curing, heat curing (e.g., via a heat lamp), or some other suitable form of curing. Therefore, according to certain embodiments, the glue/adhesive is applied at interface regions between the facets 104 and the frame 102, for example at the short sides (ends or edges) 107a and 107b of the facets 104), and is then cured using appropriate curing means. FIGS. 3G and 3H (top and side views, respectively) show amounts of glue/adhesive 106 applied at the interface regions between the facets 104 and the frame 102 prior to curing, and FIGS. 3I and 3J show the cured adhesive/glue 108. It is noted that although the drawings show that the glue 106/108 is applied to the entirety of the short sides 107a, 107b of the facets 104, the glue can be applied to only part of the short sides 107a, 107b. Furthermore, although the drawings show that the glue 106/108 is applied to both of the short sides 107a, 107b of each of the facets 104, in certain cases the glue may be applied to all or part of only one of the short sides of each facet.

In certain embodiments, all of the facets 104 may be arranged according to the spatial configuration and then bonded to the frame 102. In other embodiments, the facets may be placed and bonded one at a time. For example, a first facet may be placed in the frame according to the spatial configuration, glue/adhesive may then be applied between the first facet and the frame to fix the spatial configuration, and the glue/adhesive may then be cured. A next facet may then be placed and bonded, and so on.

Once all of the facets 104 are bonded to the frame 102, the spatial configuration of the facets 104 is fixed, whereby the facets are mutually parallel. Regions of the frame unoccupied by the facets 104 are then filled with a transparent optical material which forms the bulk of the fabricated optical device. The unoccupied regions are represented in the side view of FIG. 3J as 110, and the transparent optical material that is filled in the previously unoccupied regions 110 is represented in FIG. 3K as dotted regions 112. In certain preferred embodiments, the facets 104 are constructed from the same material as the transparent optical material 112 that fills the frame 102.

The transparent optical material 112 can be, for example, a plastic, glass, or polymer resin, which can be injected into the regions 110 via any suitable injection means. The injected resin 112 can then be cured, for example via UV and/or heat curing (e.g., via a UV lamp and/or a heat lamp) in order to solidify/harden, thereby forming the bulk of the optical device.

In order to support propagation of light by internal reflection, LOEs require parallelism between the pair of major external surfaces. In order to produce an LOE with parallel major external surfaces, the frame 102 is preferably arranged between a pair of parallel surfaces 114a and 114b such that the facets 104 are located between the parallel surfaces 114a and 114b, prior to the unoccupied regions 110 being filled with the transparent optical material. This is illustrated in FIG. 3L (side view). The parallel surfaces 114a and 114b may be implemented, for example, as a pair of parallel transparent glass or plastic plates or non-transparent carrier plates.

FIG. 3M is similar to FIG. 3L, but shows the uncured transparent optical material 112 that fills the previously unoccupied region. FIG. 3N shows the transparent optical material post-curing, represented as cross-hatching 112′.

After the transparent optical material 112′ has been cured (to harden), the frame and the surfaces (e.g., plates) 114a and 114b can be removed, to reveal the fabricated optical device with embedded optical elements 104. The major external surfaces of the optical device may then optically be polished. In certain cases, the fabricated optical device can be left in the frame, if, for example, the frame will not interfere optically with the optical function of the optical device.

In certain embodiments, the facets can be arranged according to an alternating double-side coated and un-coated configuration, such that each double-side coated facet is adjacent to an un-coated facet, and such that each un-coated facet is adjacent to a double-side coated facet. Such a configuration can achieve a similar result as the alternating arrangement described in PCT publication WO 2020/212835.

As should be apparent, the optical performance of the optical device is largely dependent on properly arranging of the optical elements 104 according to the appropriate spatial configuration. In practice, misalignment of the optical elements may lead to decreased optical performance. Various methods can be used to arrange the facets (or generally the optical element) 104 in the frame 102 according to the spatial configuration with high accuracy. According to certain embodiments of the present disclosure, a device is deployed to arrange the facets 104 according to the spatial configuration.

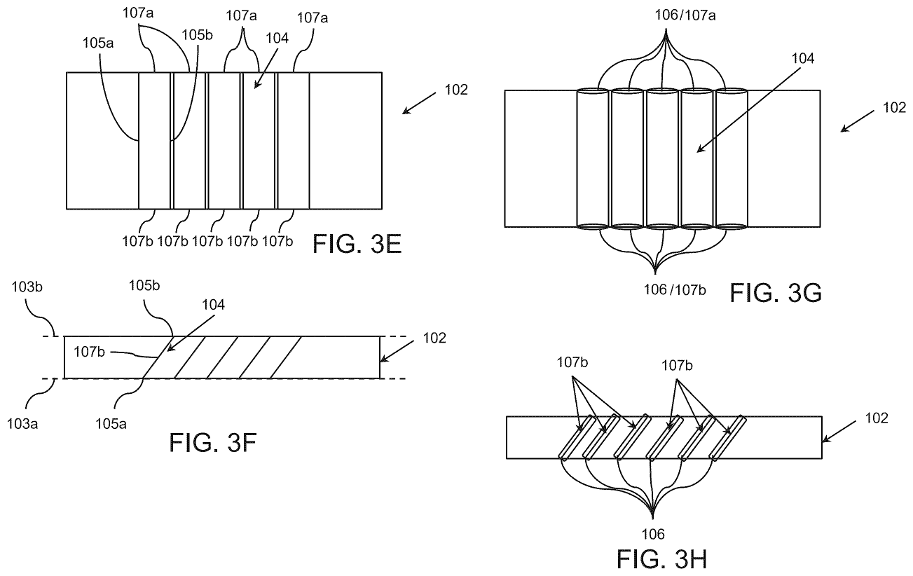

In one set of non-limiting embodiments, the device is implemented as a surface-mount technology (SMT) component placement system, commonly referred to as a pick-and-place machine, which is a robotic machine, typically having one or more robotic arm, that is controlled by a hardware processing unit and have one or more computerized processors coupled to one or more computerized storage (e.g., memory) that store program code for controlling the robotic arms. The robotic machines typically employ optical systems that perform calculations pertaining to the spatial location and orientation of the devices being placed. These robotic machines are common-place in the semiconductor industry, for high-speed, high-precision placement of electronic components onto printed circuit boards, and are commonly available, for example from companies such as Fuji, Panasonic, Yamaha, and Hitachi. FIG. 4 illustrates a particular example of a pick-and-place robot 120 with a robotic arm 122, available from Mecademic of Canada, that can be used for arranging the optical element(s), e.g., facets 104, in the frame 102 according to the spatial configuration with high accuracy. The specific pick-and-place robot illustrated in FIG. 4 is one non-limiting example of a pick-and place robot that can be used with embodiments of the present disclosure.

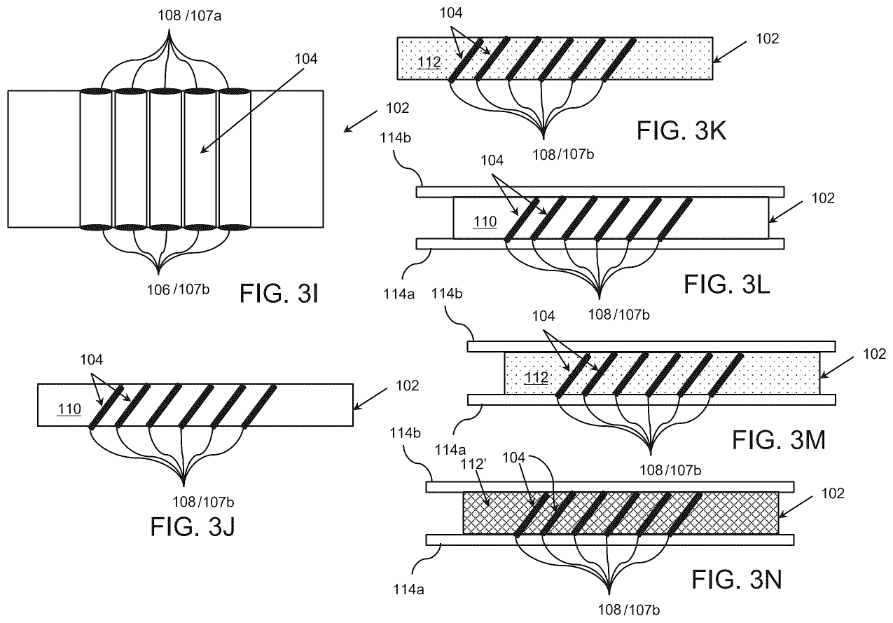

In another set of non-limiting embodiments, for example as illustrated in FIG. 5, the device is implemented as an optical-test bench equipment (commonly referred to as a “jig”) 130 for placing and aligning optical components. The jig 130 includes frame holding equipment 132 and optical element placement equipment 140.

The frame holding equipment 132 can include a frame holder 133 for holding the frame 102. The frame holder 133 can be mechanically coupled (e.g., mounted) to a rotatable stage 134 that provides adjustment of a yaw angle of the frame 102. The rotatable stage 134 may be mechanically coupled (e.g., mounted) to a roll goniometer 136 that provides adjustment of a roll angle of the frame 102. The roll goniometer 136 may be mechanically coupled (e.g., mounted) to a pitch goniometer 138 that provides adjustment of a pitch angle of the frame 102. The components 134, 136, 138 provide multiple-degree of freedom of positioning/orientation of the frame 102.

The optical element placement equipment 140 can include a mechanical arm 142 for placing the optical element (facet) 104 in the frame 102. The mechanical arm 142 can be mechanically coupled (e.g., mounted) to a rotatable stage 144 (for example via a rod 143) that provides adjustment of a yaw angle of the mechanical arm 142. The rotatable stage 144 may be mechanically coupled (e.g., mounted) to a roll goniometer 146 that provides adjustment of a roll angle of the mechanical arm 142. The roll goniometer 146 may be mechanically coupled (e.g., mounted) to a pitch goniometer 148 that provides adjustment of a pitch angle of the mechanical arm 142. The pitch goniometer 148 may be mechanically coupled (e.g., mounted) to a positioning stage 149 that provides lateral movement of the placement equipment 140. The components 144, 146, 148, 149 provide multiple-degree of freedom of positioning/orientation of the mechanical arm 142.

The jig 130 may further include an autocollimator 150 and an imager (camera) 152, which can be used to measure spatial location and orientation of the optical element relative to the frame. The combination of the components of the jig 130 enable the jig 130 to place the optical elements in the frame according to the requisite spatial configuration with high accuracy.

In certain embodiments, the frame 102 can be provided with structure that provides temporary holding of the facets according to the requisite spatial configuration. For example, according to certain embodiments, the frame 102 can be fitted with one or more pairs of channels or grooves (a pair for each facet) that define the spatial configuration of the facets. The facets and the channels/grooves are correspondingly configured so that the facets can be held in the frame by placement in the channels or grooves, thereby allowing temporary holding of the facets in the frame prior to bonding and filling-in of the transparent optical material.

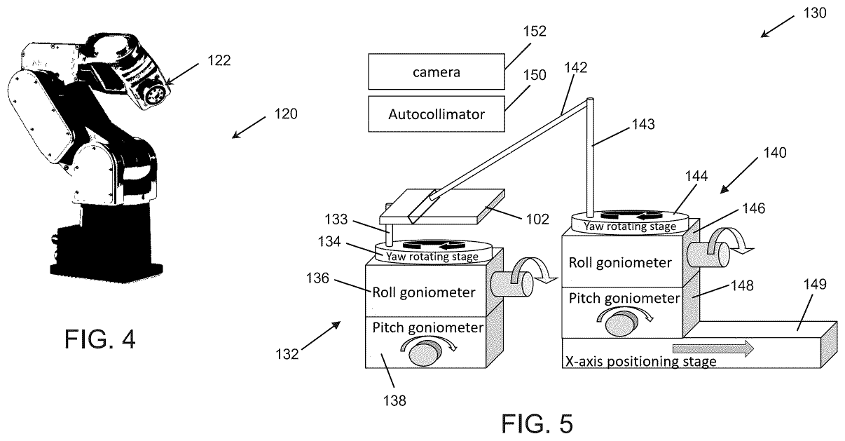

In certain embodiments, an optical element magazine can be used to temporarily store the optical element(s) in a temporary spatial configuration prior to placement in the frame 102, and the magazine can be positioned relative to the frame such that the optical element(s), when stored in the in the magazine, are relatively positioned in their final positions so that the optical element(s) can be quickly dumped into the frame in the correct spatial configuration. Such embodiments are particularly useful for mass-production of optical devices, for example in an assembly line. FIG. 6 illustrates an embodiment that employs multiple facet magazines 160, each temporarily storing a set of facets 104 that are to be placed in corresponding frames. In the figure, a first of the frames 102a is complete (i.e., all of the facets 104a in the frame 102a are properly placed and bonded), a next one of the frames 102b is in progress of being filled by one of the facet magazines 160 (i.e., some of the facets 104b are properly placed and bonded), and a next one of the frames 102c is empty, awaiting filling from another one of the facet magazines 160.

The methods described thus far are suitable for producing various types of optical devices, exemplarily including LOEs, which can be 1D LOEs such the LOE illustrated in FIG. 1, as well as 2D LOEs such as the LOE illustrated in FIG. 2. The spatial configuration of the facets in the frame can be chosen according to the type of LOE and the required position and orientation of the facets in the final LOE product. For example, when constructing a 1D LOE or 2D LOE in which the facets 104 will become the facets 18 in the final LOE product, the facets 104 should be placed in the frame 102 so that the orientation of the facets defined by the spatial configuration is such that the facets 104 are mutually parallel, and preferably such that the facets 104 are obliquely inclined to pair of parallel surfaces 114a and 114b or planes 103a and 103b between which the frame is located. As another example, when constructing a 2D LOE in which the facets 104 will become the facets 17 in the final LOE product, the facets 104 can be placed in the frame 102 so that the orientation of the facets defined by the spatial configuration is such that the facets 104 are mutually parallel, and optionally such that the facets 104 are obliquely inclined to the pair of parallel surfaces 114a and 114b or planes 103a and 103b or such that the facets 104 are perpendicular to the pair of parallel surfaces 114a and 114b or planes 103a and 103b. When constructing a 2D LOE, a first set of the facets 104 (corresponding to the facets 18) can be arranged according to a first spatial configuration so that they are mutually parallel and are obliquely inclined relative to the pair of parallel surfaces 114a and 114b or planes 103a and 103b, and a second set of the facets 104 (corresponding to the facets 17) can be arranged according to a second spatial configuration so that they are mutually parallel and have an orientation (defined by the second spatial configuration) that is non-parallel to the orientation of the first set of facets.

As mentioned, in certain embodiments, the same type of optical material is used to fabricate the facets and to fill the frame. In other words, in certain embodiments, the facets and the bulk of the optical device are formed from the same material. In preferred embodiments, this material is a low-density material, which provides additional advantage of the final optical device (e.g., LOE) product being lower weight than conventional LOEs. Examples of types of low-density materials includes plastics, certain types of glass, and polymers. As mentioned, when such materials are used as the bulk of the LOE, they can be injected as a resin and then cured to solidify.

One class of optical materials that provide particular advantage when used in the fabrication methods discussed above are materials that have low or high glass-transition temperature (T_{g}), specifically low T_{g} glass and high T_{g} plastic/polymer materials. The terms “low” and “high” are defined here within the particular context of the type of material that is “low” or “high” T_{g}. For example, for plastic or polymer materials “high” T_{g} is defined here as greater than around 100° C. For glass, “low” T_{g} is defined as preferably approximately 380° C., but in certain cases, for example where oxide coatings are used to produce partial reflectivity of glass facets, glass with higher T_{g} is acceptable, for example approximately 560° C. or even higher. In addition to being low-density and thus light-weight, one advantage of using high T_{g} plastic/polymer in LOE fabrication methods is that less material is wasted during the fabrication process (as compared to materials used in conventional LOE fabrication methods). In certain embodiments, both the facets themselves, as well as the optical material used for filling-in the frame after the facets are bonded to the frame, are made of the same low or high T_{g} material. In such embodiments, after the frame is filled with the low or high T_{g} optical material (resin), the optical device under fabrication can be heated to a temperature that is close to T_{g} in order to reduce birefringence, and to increase the overall refractive index homogeneity of the optical device. Low or high T_{g} materials that are suitable for constructing the facets and filling-in the frame include, for example, cyclo olefin polymer (COP) having T_{g} between 120° C. and 160° C., cyclo olefin copolymer (COP) having T_{g} between 130° C. and 180° C., and low T_{g} P-PK53 glass.

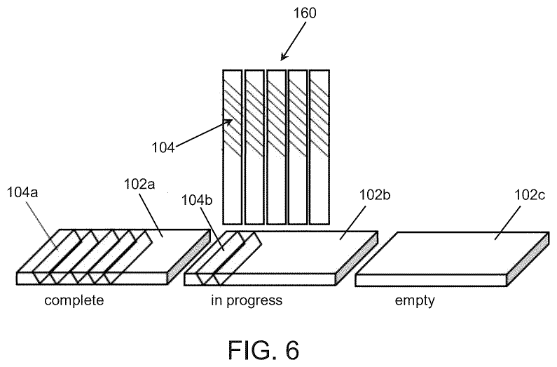

Referring now to FIGS. 7A-7C, there is described methods for fabricating facets constructed from a low or high T_{g} material according to non-limiting example embodiments of the present disclosure.

With particular reference to FIG. 7A, a production plate 170, formed from a transparent material having a low or high T_{g}, is obtained, and is coated on a single side with a partially-reflecting coating 172. The plate 170 can be cold coated with the coating 172, for example by a physical vapor deposition coating process or by a sputtering coater, where the temperature of the coating 172 is less than T_{g}. Alternatively, the plate 170 can be coated using a sacrificial layer 174 on a substrate/plate of low T_{g} glass or high T_{g} plastic/polymer or even of higher T_{g} glass (for example glass having T_{g} in a range between 120° C. and 600° C., for example BK7 glass, which has T_{g} of approximately 557° C.). This can be used to replicate the coated thin film layers from a higher T_{g} plate to the final low or high T_{g} plate. In embodiments in which a sacrificial layer 174 is deposited on the plate 170, and then the sacrificial layer 174 is coated with coating 172, an optional thick layer of optical glue can be applied to the coating layer 172 and then the sacrificial layer 174 can be removed. As an additional option, the partially-reflecting coating 172 can be applied to both sides of the plate 170 to produce a double-side coated facet.

In certain embodiments, the coated 170 can be sized and dimension to produce a single facet. In other embodiments, for example as shown in FIG. 7B, the coated plate 170 can be sized and dimension to produce multiple facets, and the coated plate 170 is sliced (cut) along a set of cutting planes to produce multiple smaller-sized coated plates, where each smaller-sized coated plate is (corresponds to) a facet 104. In FIG. 7B, the coated plate 170 is cut along a set of five cutting planes, where four of the cutting planes 176 are mutually parallel and evenly spaced, and the fifth cutting plane 178 is perpendicular to the planes 176, thereby producing ten facets 104.

For larger-scale production of facets 104, a plurality of coated plates 170 (for example each being according to FIG. 7A, with or without sacrificial layer 174) can be produced and then arranged in a stack 180, for example as illustrated in FIG. 7C. The plates 170 in the stack 180 can be temporarily bonded together using a temporary adhesive 182, for example layered between the coating 172 of one plate and the uncoated surface of the adjacent plate 170. The stack 180 can then be cut along a set of cutting planes, for example similar to as in FIG. 7B, to produce multiple stacks of smaller-sized coated plates. The temporary adhesive between the coated plates in each stack can then be removed to separate out the individual smaller-sized coated plates, each being a facet.

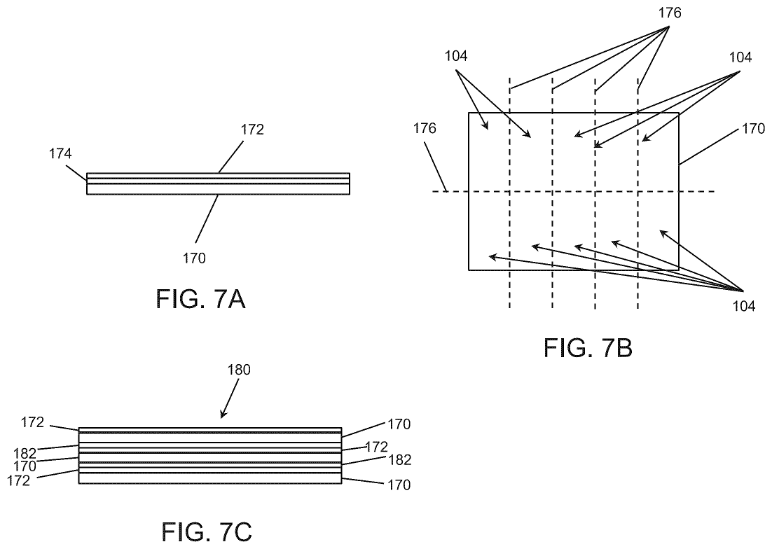

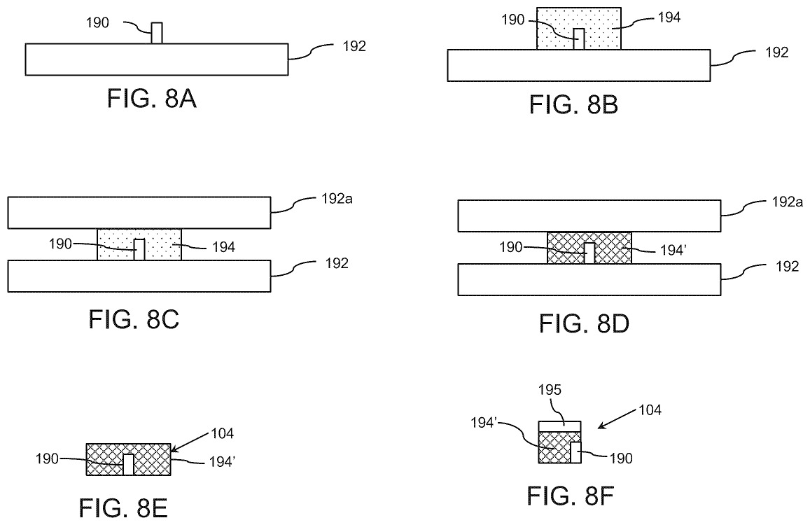

Referring now to FIGS. 8A-9F, there is described methods for fabricating facets according to another non-limiting example embodiment of the present disclosure. Here, each of the facets has an embedded material, that is internal to the facet, that is sensitive to at least one of an electric field or a magnetic field. The embedded material can be, for example, a magnetic material, such as a ferromagnetic particle or particles, and a dielectric material. The facet bulk material can be any optical material that exhibits partially reflective properties, such as, for example optical glue, glass, plastic, or polymer.

With particular reference to FIG. 8A, an amount of the embedded material 190 (implemented in the example as ferromagnetic material) is placed on a carrier plate, 192, which is preferably a flat plate. A magnet (not shown) can be used to move the ferromagnetic material 190 to a requisite position on the carrier plate 192. Then, as shown in FIG. 8B, an amount of facet bulk material (represented in the figure as dotted region 194), for example optical glue, is placed on the carrier plate 192 such that the ferromagnetic material 190 is embedded within the bulk material 194, i.e., is internal to the bulk material 194. Optionally, as illustrated in FIG. 8C, another flat plate 192a can be placed on top of the bulk material 194 so that the bulk material 194, with the ferromagnetic material 190 embedded therein, is sandwiched between the plates 192 and 192a. The plates 192 and 192a can be pressed together, which can aid in flattening out the bulk material 194 to the desired thickness. Next, the bulk material 194 can be cured, for example via UV and/or heat curing (e.g., via a UV lamp and/or a heat lamp) so that the bulk material 194 solidifies/hardens. FIG. 8D shows the bulk material post-curing, represented as cross-hatching 194′.

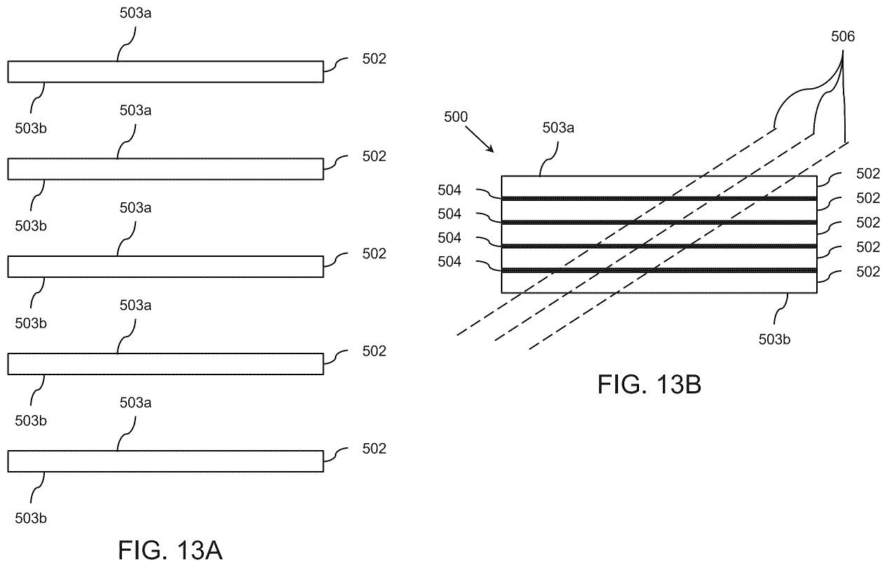

Once the bulk material is cured, the top flat plate 192a can be removed, and then a portion of the cured material, having the ferromagnetic material 190 embedded therein, is removed from the carrier plate 192 to form facet 104, as shown in FIG. 8E. Optionally, the facet 104 can be trimmed down in size and/or dimension, as shown in FIG. 8F. In certain embodiments, a coating layer or layers 195, for example a thin film coating (which can be a multi-layer coating) and/or one or more optical sheets (for example available from 3M), can be applied to the cured bulk material 194′, before or after removal from the carrier plate 192, and before or after trimming down the facet in size and/or dimension. The coating layer(s) 195 can be partially-reflecting coating that provide the facet 104 with its partial reflectivity. In other embodiments, partial reflectivity of the facet can be effectuated by utilizing a high index or medium index optical glue as the facet bulk material 194′, and utilizing a lower index material (either a medium index material, or a low index material) as the LOE bulk material. The embedding of a high index material in a lower index bulk LOE material to affect facet partial reflectivity will be discussed in further detail below in the context of another embodiment, and with reference to FIGS. 13A and 13B.

The production method illustrated in FIGS. 8A-8F can be expanded for larger-scale production of facets, as will now be discussed with reference to FIGS. 9A-9F. In FIG. 9A, multiple particles of ferromagnetic material 190 are placed on the carrier plate 192, and can be aligned and distributed to requisite positions via a magnet. FIG. 9B shows the aligned ferromagnetic material 190 on the carrier plate 192. FIG. 9C shows optical glue 194 (or other suitable partially-reflecting bulk material) placed on the carrier plate 192 such that the aligned ferromagnetic material 190 is embedded in the optical glue 194. The bulk material 194 can be sandwiched between the carrier plate 192 and another flat plate in order to flatten out the bulk material 194 to desired thickness, as discussed above. The optical glue 194 can then be cured, as discussed above. FIG. 9D shows the optical glue 194′ post-curing. Once the optical glue is cured, the cured material 194′, having the aligned ferromagnetic material 190 embedded therein, is removed from the carrier plate 192, as shown in FIG. 9E, and is then cut to form individual facets 104, each having ferromagnetic material embedded therein, as shown in FIG. 9F. In embodiments in which partial reflectivity of the facets is effectuated by partial-reflecting coatings, thin film coatings and/or one or more optical sheets can be applied to the cured bulk material 194′ before or after removal from the carrier plate 192 (similar to as described above and shown in FIG. 8F), and preferably before the cured bulk material 194′ is cut to form the individual facets.

In certain embodiments, an amount of dielectric material can be embedded within the facet, in addition to, or instead of, ferromagnetic material. The embedding can be achieved using the same or similar techniques described above for embedding ferromagnetic material. According to certain embodiments, the orientation of the embedded magnetic and/or dielectric material can be adjusted prior to curing of the bulk material.

The processes described with reference to FIGS. 8A-9F can be used to fabricate a plurality of very small-scale partial reflectors, i.e., facet fragments. In certain embodiments, a group of facet fragments can be oriented in the bulk material so as to function as a single unitary facet structure. In such embodiments, the facet fragments (each having embedded magnetic and/or dielectric material) of the group can be angularly oriented prior to condensing bulk material.

Although the embodiments discussed above with reference to FIGS. 8A-9E were described within the non-limiting example context of the facet bulk material being high refractive index or medium refractive index optical glue, embodiments in which other materials are used to form the facet bulk are contemplated herein, for example, embodiments in which high or medium refractive index glass, plastic, or polymer, are used to form the facet bulk. In such embodiments, the glass, plastic, or polymer material can be placed on the carrier plate 192 as a resin, and then cured to harden. In other embodiments, the facet material is index matched to the LOE bulk material and can be used for manipulating the optical coating(s)/optical sheets (e.g., from 3M) (that effectuates partial-reflectivity) to achieve the desired spatial orientation.

In certain embodiments, facets with embedded magnetic material and/or dielectric material can be produced using a frame structure. For example, an amount of magnetic material and/or dielectric material can be placed in a frame structure that is sized and dimensioned corresponding to the size and dimension of a single facet, or sized and dimensioned corresponding to the size and dimension of a plurality of adjoined facets (e.g., facets arranged side by side). The frame structure can then be filled with a facet bulk material, for example, optical glue, glass resin, plastic resin, polymer resin. The bulk material can then be cured to harden, and the facet structure, with embedded magnetic material and/or dielectric material can be removed from the frame. If producing a plurality of facets, the facet structure can then be cut to extract individual facets, each having embedded magnetic material and/or dielectric material internal to the facet. Optionally, a thin film coating and/or one or more optical sheets can be applied to the facet(s), either before or after removal from the frame.

In other embodiments, a facet mold can be used to produce facets with embedded magnetic material and/or dielectric material. For example, a mold that corresponds to the size and dimension of a single facet, or that corresponds to the size and dimension of a plurality of adjoined facets (e.g., facets arranged side by side), can be obtained. The magnetic material and/or dielectric material can be placed inside the mold, and then the facet bulk material (e.g., optical glue, glass resin, plastic resin, polymer resin) can be injected into the mold. The bulk material can then be cured to harden, and the facet structure, with embedded magnetic material and/or dielectric material can be removed from the mold.

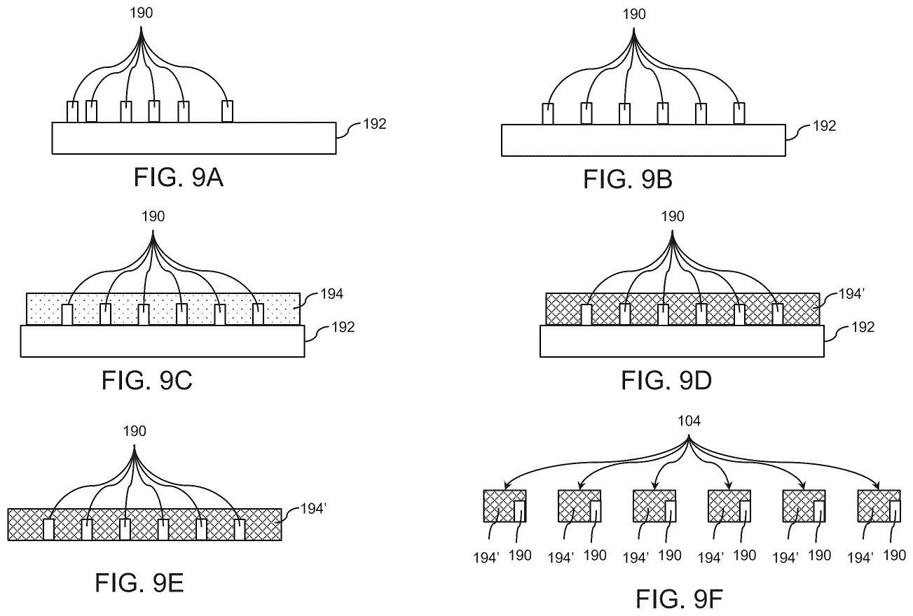

The facet(s) having embedded magnetic material and/or dielectric material can be arranged in the frame 102 according to the appropriate spatial configuration using a pick-and-place machine and/or a jig, for example as described above. However, arrangement of such facet(s) can also be performed at least in part by employing an apparatus having a device that applies a controlled electric field and/or a controlled magnetic field to the facet such that the electric field and/or the magnetic field is controllably applied to the embedded material that is internal to the facet. FIG. 10 schematically illustrates a non-limiting example embodiment of an apparatus 200 that can be used to arrange the facets of FIGS. 8A-9F in a frame 102. The apparatus 200 includes a stage 202 that supports the frame 102, and a device 204 configured to produce controlled electric fields 206a and/or magnetic fields 206b of controllable magnitude. In one configuration, the device 204 produces controlled electric fields 206a and/or magnetic fields 206b to controllably manipulate the position and orientation of the facet in three-dimensional space so as to place the facet in the frame 102 according to the requisite spatial configuration. The device 204 typically includes a computerized control system, implemented, for example, as a computerized processor or controller coupled to a storage memory (e.g., memory), that controls the device 204 to produce the electric fields and/or magnetic fields. For example, the control system can actuate the device 204 to produce the electric fields and/or magnetic fields and can vary the magnitude/strength of the produced electric fields and/or magnetic fields, for example by varying an applied voltage in time and space. In another configuration, the placement of the facet in the frame 102 according to the requisite spatial configuration can be aided by the stage 202, which can be implemented as a moveable stage that is moveable along two or three axes of movement and preferably also tiltable about two or three tilt axes. In such a configuration, the device 204 and the stage 202 can have separate control systems, or more preferably a single control system can be used to control both the production of the electric fields and/or magnetic fields by the device 204 and the movement of the stage 202. Various types of devices can be used to produce controlled electric fields and magnetic fields, including, for example, stepper motors, which are well-known in the art.

Once the facets with embedded magnetic material and/or dielectric material are properly arranged in the frame, the facets are bonded in place to the frame, for example using a low index or medium index optical adhesive, which can be UV cured. The frame can then be filled with a transparent optical material to form the bulk of the optical device. As discussed above, the transparent optical material can be, for example, a plastic, glass, or polymer resin, which can be injected into the unoccupied regions of the frame as a resin via any suitable injection means. The injected resin can be allowed to solidify/harden, preferably using curing, for example via UV and/or heat curing (e.g., via a UV lamp and/or a heat lamp), to speed up the hardening process, thereby forming the bulk of the optical device.

In certain embodiments, the bulk material resin is a low refractive index optical adhesive or a medium refractive index optical adhesive. The embedding of a high index material in a low or medium index bulk LOE material to affect a partially reflective layer will be discussed in further detail below in the context of another embodiment, and with reference to FIGS. 13A and 13B.

In the embodiments described thus far, the steps for fabricating optical devices have generally included placing fabricated facets (or other optical elements) in a frame structure at a prescribed position and orientation (spatial configuration), bonding the facets to the frame, and then adding a bulk material (e.g., low or high T_{g} material resin) to the frame. However, other embodiments are contemplated herein in which the bulk portion of the optical device is pre-constructed, preferably as a single piece, and has defined openings configured for receiving optical elements (e.g., facets, etc.), and the optical elements (e.g., facets, etc.) are placed in the openings and bonded to the bulk portion. Embodiments of such methods will now be described, with reference to FIGS. 11A-11D. Initially, it is noted that FIGS. 11A-11D illustrate a particular example construction of an optical device implemented as a 2D LOE having two sets of facets, where the facets in a set are mutually parallel but the two sets of facets have non-parallel orientations. However, as will be discussed, the method of FIGS. 11A-11D can be used to fabricate various optical devices, including 1D LOEs, as well as optical devices having non-facet types of optical elements instead of, or in addition to, facet types of optical elements.

Referring now to FIG. 11A, a solid block 300 of transparent material is obtained. The block 300 can be formed from any suitable optical material, including, for example, glass or plastic. In certain non-limiting embodiments, the block 300 is formed from a low T_{g} glass material or a high T_{g} plastic/polymer material.

One or more portions/sections of the transparent material can then be cut-out (removed) from the solid block 300 to yield a solid block 302 having one or more openings 304a, 304b in the places where the material was removed from the block 300, as shown in FIG. 11B. The portion(s)/section(s) of transparent material can be removed, for example, by laser etching, a charged particle beam, or other suitable means.

In preferred embodiments, the openings 304a, 304b are hollow openings that extend between opposite faces (sides) of the block 302 (only one face 308 is shown in the drawings). In certain embodiments, the openings can be slits, slots, channels, or hollow grooves, formed in the block 302.

Each opening 304a, 304b defines an internal surface 306a, 306b of the block 302, and has a spatial configuration that defines a position of the internal surface 306a, 306b in the block 302 and an orientation of the internal surface 306a, 306b relative to an external face of the block 302. In the illustrated embodiment, the spatial configuration of the openings 304a is such that the internal surfaces 306a are mutually parallel, and the spatial configuration of the openings 304b is such that the internal surfaces 306b are mutually parallel but non-parallel to the internal surfaces 306a. Furthermore, the spatial configuration of the openings 304b is such that the internal surfaces 306b are obliquely inclined relative to the face 308 of the block 302. The spatial configuration of the openings 304a may be such that the internal surfaces 306a are obliquely inclined relative to the face 308, or perpendicular to the face 308.

A plurality of facets 104a and 104b is also obtained, as shown in FIG. 11C. Each of the openings 304a, 304b is configured to receive corresponding one of the optical element (facets 104a, 104b). In particular, the openings 304a, 306b and the facets 104a, 104b are correspondingly configured (i.e., in size and dimension). As shown in FIG. 11D, each one of the openings 304, 306 receives a corresponding one of the facets 104a, 104b. In other words, each one of the facets 104a, 104b is inserted into a corresponding one of the openings 304a, 304b. The inserted facets 104a, 104b are then bonded in the openings, thereby bonding the facets in the block 302. Each of the facets 104a, 104b has a spatial configuration, and as a result of corresponding configuration of the openings 304a, 304b and the facets 104a, 104b, the facets 104a, 104b inherit the spatial configuration of their corresponding openings 304a, 304b. It is noted that if optically active regions of the facets (i.e., the regions that will reflect or transmit image illumination) are bonded to the openings, an optical glue should be used for the bonding. If, on the other hand, optically inactive regions of the facets (i.e., regions that do not usably deflect or transmit image illumination) are bonded to the openings, a non-optical glue can be used for the bonding.

The facets 104a, 104b can be manufactured, for example, using any of the techniques previously described, or any other suitable technique. For example, in certain embodiments, all of the facets 104a, 104b are formed from transparent plates, each coated on one side with a partially-reflecting coating (i.e., single-side coated facets). In other embodiments, some of the facets 104a, 104b are double-side coated facets and some of the facets 104a, 104b are un-coated facets. In certain embodiments, an alternating arrangement of double-sided coated facets and un-coated facets can be inserted in the openings, such that each opening that receives a double-sided coated facet is adjacent to an opening that receives an un-coated facet, and such that each opening that receives an un-coated facet is adjacent to an opening that receives a double-sided coated facet. Such a configuration can achieve a similar result as the alternating arrangement described in PCT publication WO 2020/212835.

In certain embodiments, a pair of surfaces, such as cover plates, can be provided on the opposite faces of the block 302 (i.e., on face 308 and its opposing face). The pair of surfaces are preferably arranged so that they are mutually parallel, which may require adjustment of the pair of surfaces to account for non-parallelism between the face 308 and its opposing face. Areas or regions between the parallel surfaces and the block 302 can then be filled with a transparent filling material, such as optical glue or an index-matching liquid or resin. The transparent filling material can then be allowed to set and harden, and/or can be cured, for example using UV curing, to accelerate the hardening process.

As mentioned above, in the embodiment illustrated in FIGS. 11A-11D, the optical device being fabricated is a 2D LOE having two sets of facets, where the facets of a set are mutually parallel but the two sets of facets have non-parallel orientations. Thus, the block 302 has a first set of parallel openings 304a for receiving a first set of facets 104a, and has a second set of parallel openings 304b, non-parallel to the openings 304a, for receiving a second set of facets 104b. In principle, however, the solid block can be provided with any suitable number of openings in any suitable spatial configuration for receiving any corresponding suitable number and type of optical elements, including, for example, lenses, optical retarders, and polarizing beam splitters. In a simple embodiment, for example, a single opening can be provided, for example in an embodiment in which the optical device includes a single optical element, such as, for example, a reflective surface (e.g., mirror), a lens, a retarder, or a polarizing beam splitter.

According to certain embodiments, the block 302 having one or more openings 304a, 304b (FIG. 11B) can be produced by condensing a bulk material resin in a mold that has regions having ridges or bumps, such that when the resin hardens to form the block of bulk material, the ridges or bumps of the mold form the one or more openings 304a, 304b in the block. The facets can then be bonded to the openings, or the openings can then be filled with an appropriate optical material, such has a high index optical glue, to effectuate partial reflectivity.

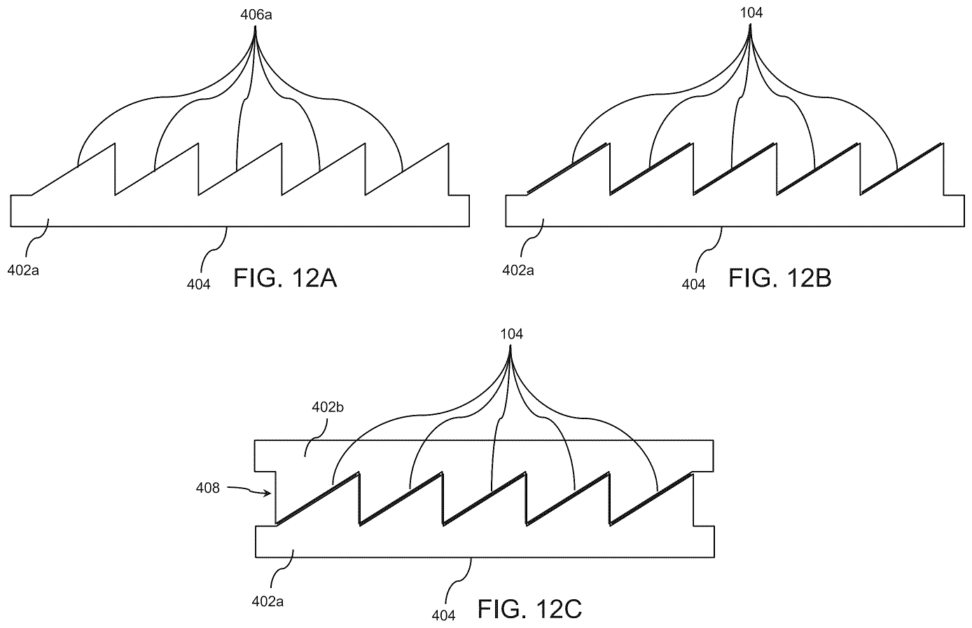

Turning now to FIGS. 12A-12C, there is illustrated a method for fabricating an LOE according to another embodiment of the present disclosure in which a set of facets is inserted into appropriate places between two similarly shaped and dimensioned optical structures, which are bonded together. In particular, as illustrated in FIG. 12A, a first optical structure 402a has a saw-tooth configuration that defines a set of surfaces 406a. Each surface 406a has a spatial configuration that defines a position of the surface 406a in the optical structure 402aand an orientation of the surface 406a relative to an external face of the optical structure 402a, for example face 404.

As illustrated in FIG. 12B, the surfaces 406a are configured to receive a corresponding set of facets 104, which can be bonded to the surfaces 406a. Once the facets 104 are placed on the corresponding surfaces 406a, the facets 104 assume the spatial configuration of the surfaces 406a. As illustrated in FIG. 12C, a second optical structure 402b, that is generally similar to the optical structure 402a, is then mated with the first optical structure 402a, and the two optical structures 402a and 402b are bonded together to form a bonded structure 408 having the facets 104 embedded therein.

In the embodiment illustrated in FIGS. 12A-12C, the facets 104 can be manufactured, for example, using any of the techniques previously described, or any other suitable technique. In one particularly preferred but non-limiting implantation, the facets 104 are constructed from a material with low or high T_{g}, for example, as described above with reference to FIGS. 7A-7C. The optical structures 402a and 402b can be manufactured in various ways, for example using injection molding or casting, and can be constructed from various optical materials, such as, for example materials with low or high T_{g}, preferably the same material used to construct the bulk portions of the facets.

In certain embodiments, the facets 104 can be constructed from a high index material, and the optical structures 402a and 402b can be constructed from a low or medium index optical material. In certain embodiments, the facets 104 can be single-side coated facets, whereas in other embodiments a first set of the facets can be double-side coated facets and a second set of the facets can be un-coated facets, and the first and second sets of facets are arranged in an alternating configuration, similar to as discussed previously.

Turning now to FIGS. 13A and 13B, there is illustrated a method for fabricating an LOE according to another embodiment of the present disclosure. In this embodiment, the partially reflecting layers (i.e., facets) of the LOE are implemented by a high index optical adhesive embedded within a low index transparent optical material, such as low index glass or low index plastic. As shown in FIG. 13A, a plurality of optical plates 502 are obtained, each having a pair of parallel major external surfaces 503a, 503b. As shown in FIG. 13B, the optical plates 502 are bonded together to form a bonded stack 500. The optical plates 502 are bonded together by providing one or more layers of optical adhesive 504 between adjacent plates 502. The optical plates 502 are formed from a low index material, such as low index glass or low index plastic, preferably having refractive index of approximately 1.5. The optical adhesive is a high index adhesive, preferably having refractive index of approximately 1.7. The bonding process can be accelerated by heat curing or UV curing the optical adhesive 504. Also as shown in FIG. 13B, the stack 500 is cut along at least two parallel cutting planes 506 that are obliquely to the major surfaces 503a, 503b of the optical plates 502 to extract one or more LOE, each extracted LOE having a pair of major external surfaces (defined by the cutting planes 506) with embedded facets (formed from the adhesive layers 504). In addition to defining the major external surfaces of the LOE(s), the cutting planes also define the oblique inclination angle of the facets (adhesive layers 504) embedded in the LOE. Specifically, the oblique angle of the cutting planes 506 relative to the major surfaces 503a, 503b of the optical plates 502 in the stack 500 define the oblique angle of the facets relative to the major external surfaces of the LOE.

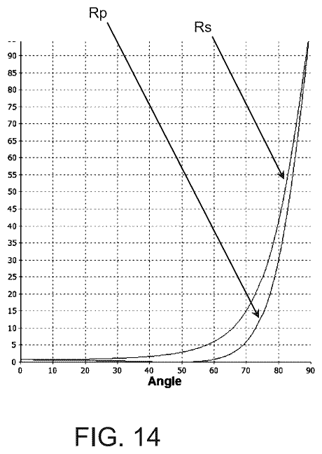

It is noted that a high index adhesive inside a low index optical medium has sufficiently achromatic reflectance for s-polarized light at angles of incidence close to Brewster's angle. Accordingly, employing an oblique angle of the cutting planes 506 of approximately 57°, for example, will lead to an LOE in which propagating image light that is s-polarized with respect to the facets and impinges on the facets at angles between approximately 40° and 60° will be coupled out of the LOE, and in which the propagating image light that impinges on the facets at angles between approximately 10° and 30° will be transmitted by the facets. This is particularly illustrated in FIG. 14, which shows that when a high index adhesive is utilized inside a low index optical medium, the reflectance for s-polarization (Rs) as function of angle is low but sufficient at an angular range of 40°-60° (as compared to reflectance for p-polarization, Rp, in the same angular range) and at the same time high transmittance for s-polarization (low Rs) is achieved at an angular range of 10°-30°.

The above-described method for implementing partially reflecting layers by embedding a high index optical adhesive within a low index transparent optical material can be extended to production methods of 2D LOEs, such as the production methods described in PCT publication WO 2021/240513, PCT publication WO 2021/152602, PCT publication WO 2021/001841, and U.S. Pat. No. 10,551,544.

In yet another embodiment, the partially reflecting layers can be formed from a high index optical adhesive, similar to the embodiment described above with reference to FIGS. 13A and 13B, but in contrast to the above-described embodiment the LOE bulk material can be formed from a low index optical adhesive instead of optical plates. In such an embodiment, both the low index and high index adhesives can be injected into molds. For example, the low index adhesive can be injected into a first set of molds that can correspond in form to the optical plates 502 of FIGS. 13A and 13B, and the high index adhesive can be injected into a second set of molds situated between adjacent molds of the first set of molds. A moveable stage (that is moveable along two or three axes of movement and preferably also tiltable about two or three tilt axes) can be used in the injection process in order to situate the molds in the correct position relative to the adhesive injectors. In certain embodiments, a UV source having one or more focused lasers can be used to cure the adhesives, providing higher resolution during the curing process.

In another embodiment, instead of injecting the high index material (used to form the facets) and the low index material (used to form the LOE bulk) into molds, the materials can be deposited onto a carrier plate that is placed on a moveable stage, or can be deposited directly onto the moveable stage itself, wherein the moveable stage is moveable along two or three axes of movement and preferably also tiltable about two or three tilt axes. In such an embodiment, the fabrication process can employ cycles of material placement (e.g., low index bulk and/or high index facet deposition), curing (e.g., UV/heat curing), cleaning or washing of residue materials (e.g., non-condensed portions of the high or low index materials), and drying. After each cycle, the stage can be moved (for example via a control system) to orient the stage (and hence the LOE under construction) in the proper orientation so that the facets assume the proper spatial configuration. As in the previously described embodiment, the curing process can employ a UV source having one or more focused lasers for curing the low index and high index materials, to provide higher resolution during the curing process. In a further embodiment, the LOE can be fabricated by building up the LOE bulk via deposition of optical bulk material and deposition of optical materials as resin in thin layers in the LOE bulk material. The deposited thin layers of optical material within the LOE bulk material mimic the optical behavior of thin film multi-layer partial reflective coatings in conventional LOE fabrication. The optical materials have different refractive indices and are deposited in thin layers (preferably on the sub micrometer scale, e.g., layer thickness below 10 nanometers and more preferably below 5 nanometers, but can also reach thickness of 1-2 microns or more) on or in the bulk material, one on top of the other, to achieve partial reflective functionality. As one non-limiting example, the LOE bulk is partially built-up by depositing multiple layers of optical bulk material (having a refractive index, for example 1.5) on a carrier plate placed on the moveable stage or directly on the moveable stage. Then, a first thin layer of a first optical material (e.g., optical glue) having a first refractive index (e.g., 1.34) is deposited on the partially built-up bulk material. Then, a second thin layer of a second optical material (e.g., optical glue) having a second refractive index (e.g., 1.6) is deposited on the first thin layer. This can continue as needed or according to the LOE optical design and/or specific facet optical requirements. The low/high layers (1.34/1.6) can iterate to fulfill the optical requirements or for example other refractive index can also iterate with a third layer of optical glue having a third refractive index (e.g., 1.5) deposited on the second thin layer, and a fourth layer of optical glue having a fourth refractive index (e.g., 1.7) deposited on the third thin layer. After each thin layer deposit, the optical material can be cured and then cleaned or washed (as discussed above). Furthermore, during the deposition of each thin layer, the moveable stage can be controllably moved to orient the stage (and hence the LOE under construction) in the proper orientation so that the thin layers (which together become a facet) assume the proper spatial configuration. This multiple thin layer and bulk material deposition can be repeated as necessary for each facet and until the LOE is completely built-up.

Throughout the present document, reference has been made to the application and/or injection of optical materials including optical adhesives and transparent optical materials in the form of resins. Such applications and/or injections can be achieved by use of suitable applicators and/or injectors (syringes) that provide electronic and/or electro-mechanical control of the deposition of optical materials including one or more of the thickness of the deposited optical materials and the location of the deposition. One suitable arrangement having suitable applicators/injectors that can be used in some of the fabrication processes disclosed herein is the FlashForge Guider 3 3D printer commercially available from FlashForge USA of Los Angeles, CA.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

As used herein, the singular form, “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable subcombination or as suitable in any other described embodiment of the disclosure. Certain features described in the context of various embodiments are not to be considered essential features of those embodiments, unless the embodiment is inoperative without those elements.

To the extent that the appended claims have been drafted without multiple dependencies, this has been done only to accommodate formal requirements in jurisdictions which do not allow such multiple dependencies. It should be noted that all possible combinations of features which would be implied by rendering the claims multiply dependent are explicitly envisaged and should be considered part of the disclosure.

Although the disclosure has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the appended claims.

1. A method for fabricating an optical device, the method comprising:
obtaining at least one optical element;
obtaining a frame;
arranging the at least one optical element within the frame according to a spatial configuration that defines a position of the at least one optical element in the frame and an orientation of the at least one optical element relative to the frame;
bonding the at least one optical element to the frame to fix the spatial configuration;
filling regions of the frame unoccupied by the at least one optical element with a transparent optical material; and
prior to filling the regions of the frame with the transparent optical material, arranging the frame between a pair of parallel surfaces such that the at least one optical element is located between the parallel surfaces.

2. (canceled)

3. The method of claim 1, further comprising:
curing the transparent optical material.

4. The method of claim 1, wherein the at least one optical element is constructed from a material that is the same as the transparent optical material.

5. The method of claim 1, wherein the at least one optical element is constructed from a glass material having a low glass-transition temperature or a plastic or polymer material having a high glass-transition temperature.

6. The method of claim 1, wherein arranging the at least one optical element within the frame includes deploying a device that places each optical element of the at least one optical element according to the spatial configuration.

7. The method of claim 1, wherein the at least one optical element has an embedded material internal to the at least one optical element that is sensitive to at least one of an electric field or a magnetic field.

8. The method of claim 7, wherein arranging the at least one optical element within the frame is performed at least in part by applying at least one of an electric field or a magnetic field to the embedded material internal to the at least one optical element.

9. The method of claim 7, wherein the embedded material includes at least one of a ferromagnetic material or a dielectric material.

10. The method of claim 1, wherein the at least one optical element includes a planar partially-reflecting surface.

11. The method of claim 1, wherein the at least one optical element includes a lens.

12. The method of claim 1, wherein the at least one optical element includes a polarizing beam splitter.

13. The method of claim 1, wherein the at least one optical element includes an optical retarder.

14. The method of claim 1, wherein the at least one optical element includes a reflective surface.

15. The method of claim 1, wherein the at least one optical element includes a plurality of optical elements.

16. The method of claim 15, wherein the plurality of optical elements includes a first plurality of planar partially-reflecting surfaces.

17. The method of claim 16, wherein the orientation defined by the spatial configuration is such that the first plurality of partially-reflecting surfaces are obliquely inclined relative to a pair of parallel surfaces between which the frame is located.

18. the method of claim 16, wherein the orientation defined by the spatial configuration is such that the first plurality of partially-reflecting surfaces are perpendicular to a pair of parallel surfaces between which the frame is located.

19. The method of claim 16, wherein the orientation defined by the spatial configuration is such that the first plurality of partially-reflecting surfaces are mutually parallel.

20. The method of claim 19, further comprising:
obtaining a second plurality of planar partially-reflecting surfaces; and
arranging the second plurality of partially-reflecting surfaces within the frame according to a second spatial configuration that defines a position of the second plurality of partially-reflecting surfaces in the frame and an orientation of the second plurality of partially-reflecting surfaces relative to the frame, wherein the orientation defined by the second spatial configuration is such that the second plurality of partially-reflecting surfaces are mutually parallel and non-parallel to the first plurality of partially-reflecting surfaces.

21. The method of claim 1, wherein the at least one optical element includes a plurality of planar partially-reflecting surfaces, and wherein obtaining the at least one optical element includes:
obtaining a production plate formed from glass having low glass-transition temperature or a plastic or polymer material having a high glass-transition temperature,
coating the production plate with a partially-reflecting coating, and
slicing the coated production plate to produce a plurality of coated plates, each coated plate being a planar partially-reflecting surface.

22. The method of claim 1, wherein the at least one optical element includes a plurality of planar partially-reflecting surfaces, and wherein obtaining the at least one optical element includes:
obtaining a plurality of production plates, each production plate formed from glass having a low glass-transition temperature or a plastic or polymer material having a high glass-transition temperature,
coating each of the production plates with a partially-reflecting coating,
stacking the coated production plates in a stack and temporarily bonding together the coated production plates with a temporary adhesive, and
slicing the stack and removing the temporary adhesive to produce a plurality of coated plates, each coated plate being a planar partially-reflecting surface.

23. The method of claim 1, obtaining the at least one optical element includes:
obtaining an amount of a material that is sensitive to at least one of an electric field or a magnetic field, and
embedding the amount of the material in an optical material to form the at least one optical element.

24.-36 (canceled)
